(19) United States
(12) Patent Application Publication
(10) Pub. No.: US 2021/0172163 A1
(43) Pub. Date: Jun. 10, 2021

(54) BUILDING FRAME, BUILDING FRAME STRUCTURE, BUILDING PANEL STRUCTURE, AND METHOD FOR CONSTRUCTING BUILDING

(71) Applicant: CDS Nu Steel Homes International Ltd., Tokyo (JP)

(72) Inventor: Taiichi SAWADA, Tokyo (JP)

(73) Assignee: CDS Nu Steel Homes International Ltd., Tokyo (JP)

(21) Appl. No.: 17/253,635

(22) PCT Filed: Jun. 19, 2018
(86) PCT No.: PCT/JP2018/023246

§ 371 Date: Dec. 18, 2020

(51) Int. Cl. E04B 1/08; E04B 1/58; E04C 2/296; E04C 2/38; E04C 3/06

(52) U.S. Cl. CPC E04B 1/08; E04B 1/5818; E04C 3/06; E04C 2/38; E04C 2/296

(57) ABSTRACT

To provide a building frame for constructing a building, the frame being stronger than reinforced concrete, and being able to be relatively easily assembled at a construction site, without skills, and within a short time. Provided are a building frame and the like, the building frame being characterized by comprising: U-shaped parts that are arranged left and right so as to sandwich a center space in a cross-sectional view; and a connection part that connects top portions, on the center side, of the left and right U-shaped parts so as to form a reverse U-shaped part, wherein the longitudinal edges, on the far side from the center, of the U-shaped parts arranged left and right in the cross-sectional view are shorter than the longitudinal edges, on the center side, connected by the connection part.

### TECHNICAL FIELD

The present invention relates to a new concrete insertion frame which can replace a reinforcing bar of reinforced concrete, a structure of a new concrete structure, a construction method, and the like.

### BACKGROUND ART

Conventionally, buildings using reinforced concrete have been built as strong buildings.

However, reinforced concrete buildings required skilled workers, such as those bundling an appropriate number of reinforcing bars and arranging them parallel to each other. Also, it is difficult to accurately calculate the strength of reinforced concrete, and at a design stage, this is partly dependent on an intuition as to how many reinforcing bars should be assembled and in what form. Because it is difficult for even skilled workers to assemble reinforcing bars exactly as designed, variations in assembled reinforcing bars inevitably occur according to the workers in the field. For example, in the Great Hanshin-Awaji Earthquake, an impossible accident which was the large-scale collapse of the Hanshin Expressway occurred. Furthermore, it is easy to reduce the number of reinforcing bars from that in a design, such as disguising in a high-rise condominium, and it is necessary to be prepared for a certain risk in constructing a building using reinforcing bars.

### CITATION LIST

### Patent Literature

### [Patent Literature 1]

Japanese Patent Laid-Open No. 59-228555

### SUMMARY OF INVENTION

### Technical Problem

As described above, reinforced concrete buildings have various risks such as the need for skilled workers, the fact that the quality of the finished building still varies, the difficulty in designing, and the tendency for such disguising to occur.

Therefore, the inventors have realized an invention in which a building frame having a bent cross section is used instead of reinforcing bars, reinforcing bars are not used to achieve a theoretical strength, products panelized at a frame manufacturing factory can be transported to a construction site and then can be assembled at the construction site relatively easily and in a short time without skilled technology, and also a building which is stronger than a reinforced concrete one can be provided.

### Solution to Problem

In order to solve the above problems, the following building frames are provided in the present invention.

A first invention of a building frame is a building frame including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part (corresponding to claim 1).

In the first invention of the building frame, a bottom side of each of the U-shaped parts has at least a predetermined straight portion in a cross-sectional view (corresponding to claim 2).

In the first invention of the building frame, an upper side of the connection part has at least a predetermined straight portion in a cross-sectional view (corresponding to claim 3).

A second invention of a building frame structure includes a cross-connection part which cross-connects the building frames (corresponding to claim 4).

In the second invention of the building frame structure, the cross-connection part is configured of a rod-shaped body which penetrates and fixes a straight portion of one building frame and a straight portion of another building frame (corresponding to claim 5).

In a third invention of a building panel structure, a wall panel which covers a main surface is disposed on the building frame structure in a contact manner (corresponding to claim 6).

In the third invention of the building panel structure, a wall panel which covers a main surface is disposed on the building frame structure in a non-contact manner (corresponding to claim 7).

In a fourth invention of a building panel structure, a heat insulating material is disposed in a frame space formed by the cross-connection parts of the building frame structure (corresponding to claim 8).

In the fourth invention of the building panel structure, a heat insulating material is disposed between the building frames disposed parallel to and adjacent to each other in the building frame structure (corresponding to claim 9).

In the fourth invention of the building panel structure, a heat insulating material is disposed between the building frame of the building frame structure and the wall panel (corresponding to claim 10).

In a fifth invention of a building panel structure, concrete is filled between the wall panels including each of the U-shaped parts of the building frame of the building frame structure (corresponding to claim 11).

In a sixth invention of a building panel structure, the wall panel is removed (corresponding to claim 12).

In a seventh invention of a building panel structure which is the building panel structure that, the building frame is a “building frame including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view have the same length as longitudinal sides thereof, on a center side, connected by the connection part” in place of or in addition to a “building frame including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part” (corresponding to claim 13).

In an eighth invention of a building panel structure which is the building panel structure that, as the building frame, a “building frame including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part” is used as a longitudinal member, and C-shaped, U-shaped, H-shaped, and L-shaped frames are used in place of or in addition to a “building frame including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part” as transverse members (corresponding to claim 14).

In a ninth invention of a building panel structure which is the building panel structure that, as the building frame, C-shaped, U-shaped, H-shaped, and L-shaped frames are used in place of or in addition to a “building frame including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part” (corresponding to claim 15).

A tenth invention of a method for constructing a building includes a building frame structure preparation process of preparing the building frame structure, a building frame structure transportation process of transporting the prepared building frame structure to a construction site, and a building frame structure assembly construction process of assembling the transported building frame structures into a building frame structure assembly (corresponding to claim 16).

The tenth invention of the method for constructing a building further includes a wall panel installation process of installing a wall panel to cover a main surface of the assembled building frame structure assembly (corresponding to claim 17).

The tenth invention of the method for constructing a building further includes a filling process of filling a space sandwiched by the wall panels or/and a heat insulating material of the building frame structure assembly with concrete (corresponding to claim 18).

An eleventh invention of a method for constructing a building includes a building panel structure preparation process of preparing the building panel structure, a building panel structure transportation process of transporting the prepared building panel structure to a construction site, and a building panel structure assembly construction process of assembling the transported building panel structures into a building panel structure assembly (corresponding to claim 19).

The eleventh invention of the method for constructing a building further includes a filling process of filling a space sandwiched by the wall panels or/and a heat insulating material of the building panel structure assembly with concrete (corresponding to claim 20).

### Advantageous Effects of Invention

According to the above-described configuration, it is possible to provide a building which can be easily and quickly assembled at a construction site by anyone and is stronger than reinforced concrete.

### BRIEF DESCRIPTION OF DRAWINGS

FIG. 1 is a conceptual diagram of a building frame according to a first embodiment.

FIG. 2 is a conceptual diagram of the building frame according to the first embodiment.

FIG. 3 is a conceptual diagram for explaining a manufacturing procedure of the building frame.

FIG. 4A is a conceptual diagram showing an example of a cross-connection in a building frame structure according to a second embodiment.

FIG. 4B is a conceptual diagram showing an example of the cross-connection in the building frame structure according to the second embodiment.

FIG. 4C is a conceptual diagram showing an example of the cross-connection in the building frame structure according to the second embodiment.

FIG. 5 is a conceptual diagram showing an example of a cross-connection part in the building frame structure according to the second embodiment.

FIG. 6 is a conceptual diagram showing another example of the cross-connection in the building frame structure according to the second embodiment.

FIG. 7 is a conceptual diagram showing an example of a building panel structure according to a third embodiment.

FIG. 8 is a conceptual diagram showing an example in which a wall panel is of a non-contact type in the building panel structure according to the third embodiment.

FIG. 9 is a conceptual diagram showing an example of the building frame structure in which the wall panel is a non-contact type in a cross-sectional view.

FIG. 10 is a conceptual diagram showing an example of the building frame structure in a cross-sectional view when a space is provided between the wall panels using a spacer.

FIG. 11 is a conceptual diagram showing an example of a building panel structure according to a fourth embodiment.

FIG. 12 is a conceptual diagram showing an example of a building panel structure in which a heat insulating material is disposed between building frames.

FIG. 13 is a conceptual diagram showing a building panel structure in which a heat insulating material is disposed between the building frame and the wall panel.

FIG. 14 is a conceptual diagram showing an example of a building panel structure according to a fifth embodiment.

FIG. 15 is a conceptual diagram explaining an action of concrete filling using a building frame.

FIG. 16 is a conceptual diagram showing an example of a mode of concrete filling between the wall panels in a cross-sectional view.

FIG. 17 is a conceptual diagram showing an example of a building panel structure according to a sixth embodiment in a cross-sectional view.

FIG. 18 is a conceptual diagram showing an example of a building panel structure according to an eighth embodiment.

FIG. 19 is a flowchart showing a process flow in a method for constructing a building according to a tenth embodiment.

FIG. 20 is a flow chart showing a process flow in the construction method in which a wall panel installation process and a filling process are further added.

FIG. 21 is a flow chart showing a process flow in a method for constructing a building according to an eleventh embodiment.

FIG. 22 is a flow chart showing a process flow in the construction method in which a filling process is further added.

### DESCRIPTION OF EMBODIMENTS

Hereinafter, embodiments of the present invention will be described with reference to the drawings. The present invention is not limited to these embodiments, and can be carried out in various embodiments without departing from the gist thereof.

### First Embodiment

### <Outline of First Embodiment>

A first embodiment is a new building frame, and in particular, is one in which when frames are panelized and then concrete is poured in at a construction site, the concrete is sufficiently distributed to corners of a bent frame in a cross-sectional view.

### <Configuration of First Embodiment>

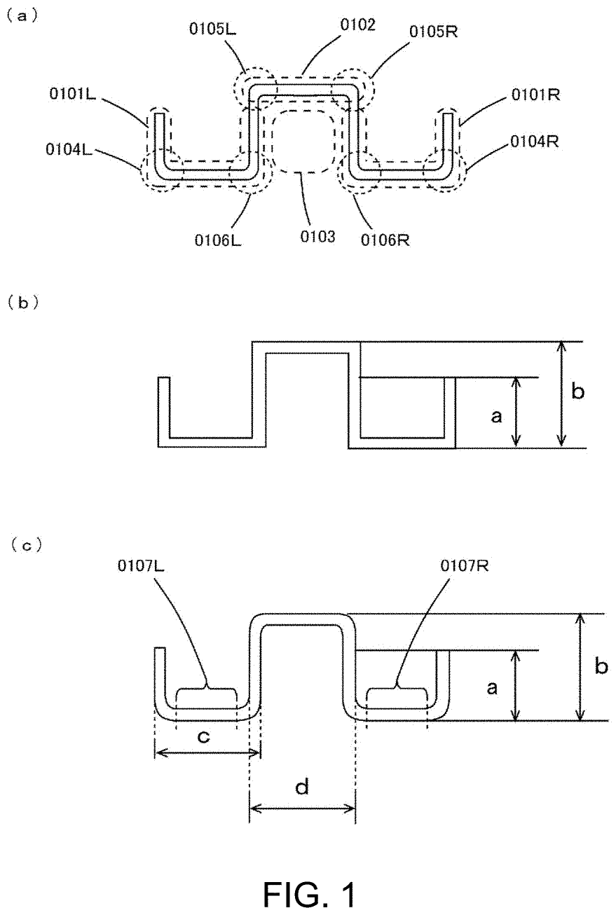

As shown in (a) of FIG. 1, a building frame of the first embodiment includes U-shaped parts 0101L and 0101R and a connection part 0102 and has a structure in which a height (a length) a of longitudinal sides, on the side away from a center portion, of the U-shaped parts 0101L and 0101R disposed on the left and right sides in a cross-sectional view is lower (shorter) than a height (a length) b of a center side connected by the connection part 0102 ((b) and (c) of FIG. 1). The building frame included in the first embodiment also includes a frame in which any additional structure may be added to a basic structure of FIG. 1. For example, a frame in which a plate-shaped member or a member which has been subjected to various deformations (for example, U, C, H, L, O, E, T, Y, K, S shapes, and the like) extends to the left side from a bent portion (a lower left end) 0104L of the U-shaped part, a plate-shaped member or a member which has been subjected to various deformations extends to the right side from another bent portion (a lower right end) 0106L of the U-shaped part, or the like, and a frame in which a plate-shaped member or a member which has been subjected to various deformations extends on a straight portion are also included in the first embodiment of the present invention (the invention of claim 1 of the present application).

### <Explanation of Configuration of First Embodiment>

### <Explanation of Configuration of First Embodiment, U-Shaped Part in General>

The “U-shaped parts” 0101L and 0101R are disposed on the left and right sides so as to sandwich a center space 0103 in a cross-sectional view, and a shape of the bent portions 0104L, 0104R, 0105L, 0105R, 0106L, and 0106R of the U-shaped part may be a curved shape or a right-angled shape. When considering processing performance of a thin steel material, a curved shape is preferable. A width c of the U-shaped part may be larger or smaller than a width d of the connection part. Of course, the width c of the U-shaped part and the width d of the connection part may be the same width. When the U-shaped part is formed in a curved shape, a curvature thereof preferably has a radius of curvature in a range of 3% to 20% of the width c of the U-shaped part, and more preferably in a range of 5% to 10% of the width c of the U-shaped part. When the radius of curvature is too large, it becomes vulnerable to shear stress on the frame, and conversely, when the radius of curvature is too small, stress is accumulated, and it becomes vulnerable to stress corrosion.

### <Explanation of Configuration of First Embodiment, Regarding Thicknesses of U-Shaped Part and Connection Part>

A thickness of the U-shaped parts 0101L and 0101R of the frame and a thickness of the connection part 0102 are about 0.4 mm or more and 2.0 mm or less. More preferably, it is about 0.6 mm or more and 1.2 mm. When a multi-story building, for example, a building with three or four floors or higher is constructed, a plate thickness needs to be increased. When it is 0.4 mm or less, mechanical strength becomes too low, and when it is 2.0 mm or more, a weight becomes too large. However, the upper limit value may exceed 2.0 mm. This is the case for high-rise buildings. As will be described later, in principle, since these frames are used in place of or in addition to reinforcing bars of reinforced concrete, it is not necessary to guarantee a structural strength of a building using only this frame structure. When concrete is formed using a frame structure which will be described later, the strength is about 20 times that of a frame structure alone.

### <Explanation of Configuration of First Embodiment, Regarding Material of U-Shaped Part and Connection Part>

A material of a base material of the U-shaped part is a rectangular metal plate, for example, a steel plate, an iron plate, a stainless steel plate, or an aluminum plate. Alternatively, a composite material thereof may be used. Surfaces of the plates (front surface: not meaning an outer surface) may be rust-proofed. For example, a galvanized steel plate may be used. Drill screws used for joining are also galvanized in the same way. A high-strength material which is a thin and lightweight material can be used. Further, magnetic steel may be used as the material, and non-magnetic steel may also be used. The connection part 0102 is made of the same material. Furthermore, in the case of a construction method in which concrete is used for a building panel structure, which will be described later, to increase the structural strength, a technique in which a frictional force with concrete is increased by providing jaggedness, unevenness, small holes or the like on a surface of the material (front surface: it does not mean an outer surface) is also useful. A method of intentionally forming a certain amount of rust (oxidation) on the surface (front surface: it does not mean an outer surface) is also effective.

### <Explanation of Configuration of First Embodiment, Regarding Processing of End Portion of U-Shaped Part>

It is desirable that end portions of the U-shaped part are processed by polishing or the like rather than being left unprocessed. This is because they easily corrode in an unprocessed state.

### <Explanation of Configuration of First Embodiment, Information Region of U-Shaped Part (Connection Part)>

When a steel frame material is assembled by combining frame components, a place on which an ID for identifying a component (a part) is printed may be provided as an information region in the U-shaped part to improve workability of an assembling work. For example, a frame identification information printing region for identifying a frame, a panel identification information printing region for identifying a wall panel or a concrete panel, a panel arrangement direction printing region for indicating an arrangement direction of a wall panel or a concrete panel, or the like may be provided as information regions. Preferably, information regions are provided on the two of the front surface and the back surface aforementioned of a building frame such that the printed information is duplicated. (Here, the surface with two grooves of a building frame is the front surface, and the surface with one groove thereof is the back side.) This is because it is preferable that information in the information region is able to confirmed from both surface sides of a wall surface of a building. Further, preferably, the information region is provided in a convex straight line region on both surfaces. This is because in this case it is less likely for it to be in a shadow. A tag recording in a way that affects the strength of the building is not preferred. However, a tag which reacts with concrete after construction and disappears but does not affect the strength of concrete may be used. For example, the tag may be a water-soluble tag. Japanese paper mixed with lime may be applied. A factory can be designed so that the building frame is automatically produced in the factory under computer control according to design drawing information (CAD information) of a building. In this case, the printing of the identification information can be configured as automatically printing according to the design drawing information. The factory can be also designed so that a process in which the building frame is assembled into a building frame structure which will be described later is also automatically performed at the factory. Due to these series of automations, the building frame structure can be manufactured almost unmanned with only the design drawing information, and thus mass production of buildings, labor saving, and speeding up can be realized in a high quality control state.

### <Explanation of Configuration of First Embodiment, Connection Part>

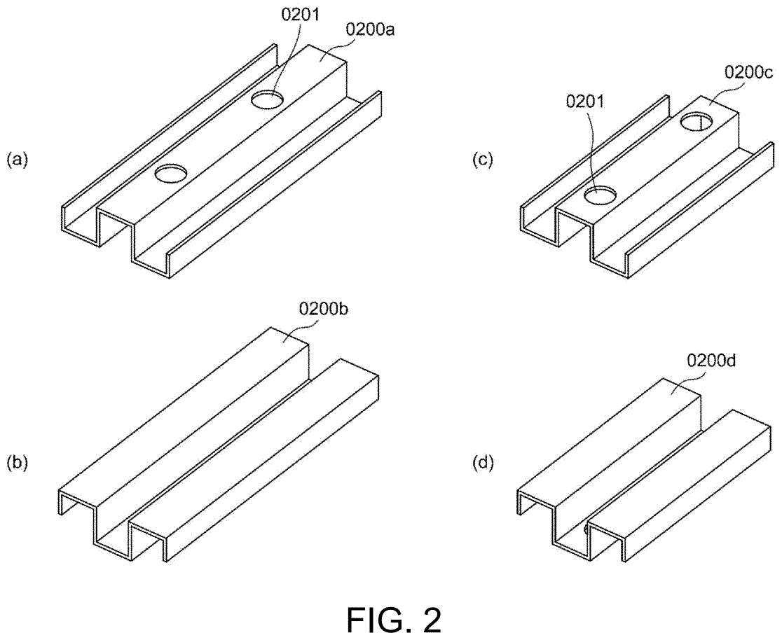

The “connection part” 0102 connects top portions of the left and right U-shaped parts 0101L and 0101R on the center side and thus forms a reverse U-shaped part. Here, as shown in FIG. 2, a concrete injection hole may be provided in the connection part. (a) of FIG. 2 shows a frame 0200a in a posture in which the connection part is located on the upper side, and (b) of FIG. 2 shows a frame 0200b in a posture in which bottom sides of the left and right U-shaped parts are located on the upper side, and a concrete injection hole 0201 is provided in the connection part. Further, (c) and (?) of FIG. 2 also show frames 0200c and 0200d in which the concrete injection holes 0201 are provided. For example, when a width of the connection part is about 30 mm, a diameter of the hole is about 20 to 25 mm. A shape of the frame can be appropriately changed according to various uses. Although the concrete injection hole is provided in the connection part shown in FIG. 2, the concrete injection hole is not an essential component of the connection part and may not be provided.

### <Explanation of Configuration of First Embodiment, Short Longitudinal Side>

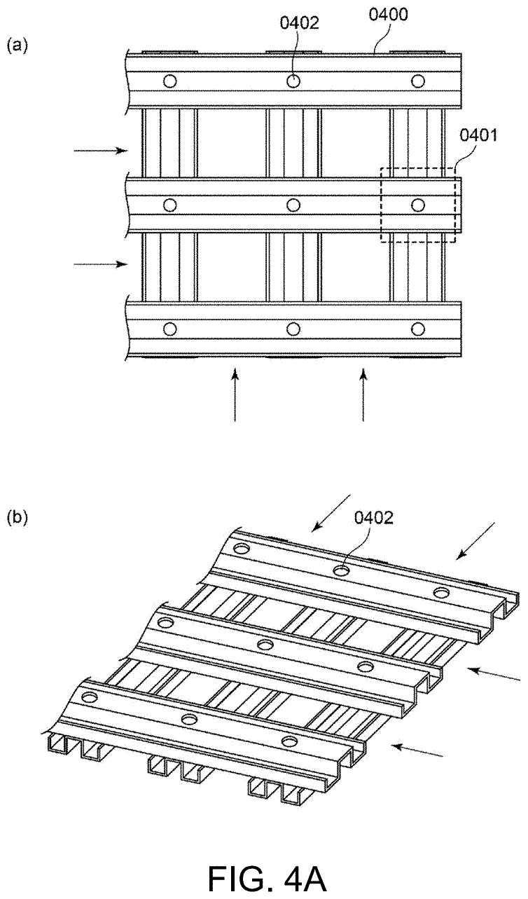

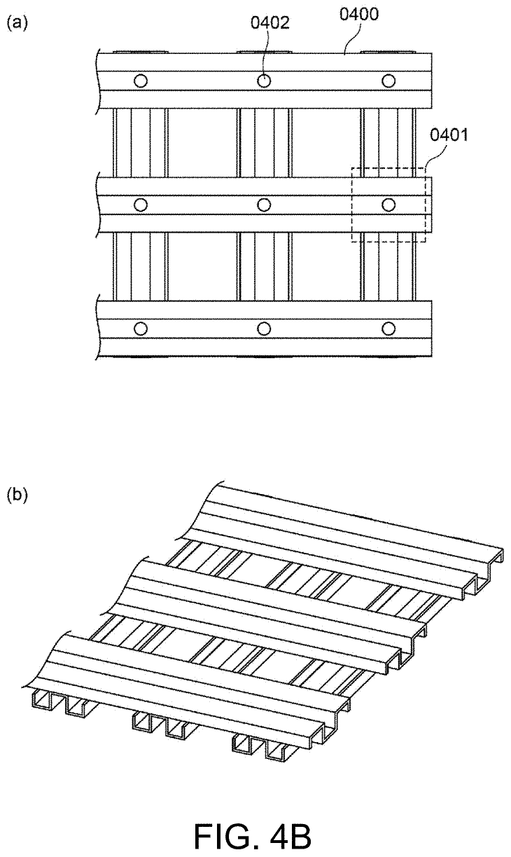

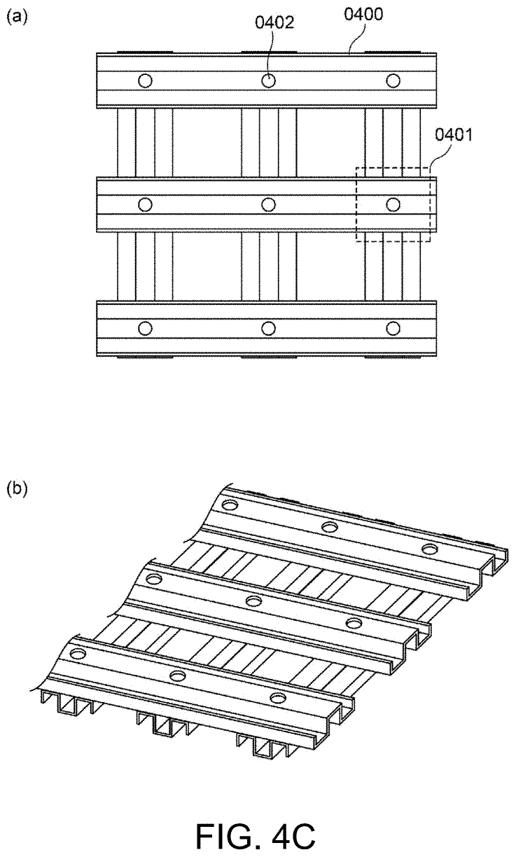

The height (the length) a of the longitudinal sides, on the side away from the center portion, of the U-shaped parts 0101L and 0101R disposed on the left and right sides in a cross-sectional view is shorter than the height b of the longitudinal sides thereof on the center side which are connected by the connection part 0102 ((B) and (C) of FIG. 1). This is to facilitate inflow of concrete from a side surface (0403a, a direction indicated by an arrow) of FIG. 4A which will be referred to later when the building frames are connected to each other.

### <Explanation of Additional Configuration of First Embodiment, Presence of a Straight Portion>

As shown in FIG. 1, the bottom sides of the U-shaped parts 0101L and 0101R have at least predetermined straight portions 0107L and 0107R in a cross-sectional view. This is to realize a close connection when the building frames are connected to each other. Therefore, preferably, an upper side of the connection part 0102 has at least a predetermined straight portion in a cross-sectional view.

### <Manufacturing Procedure of Frame of First Embodiment>

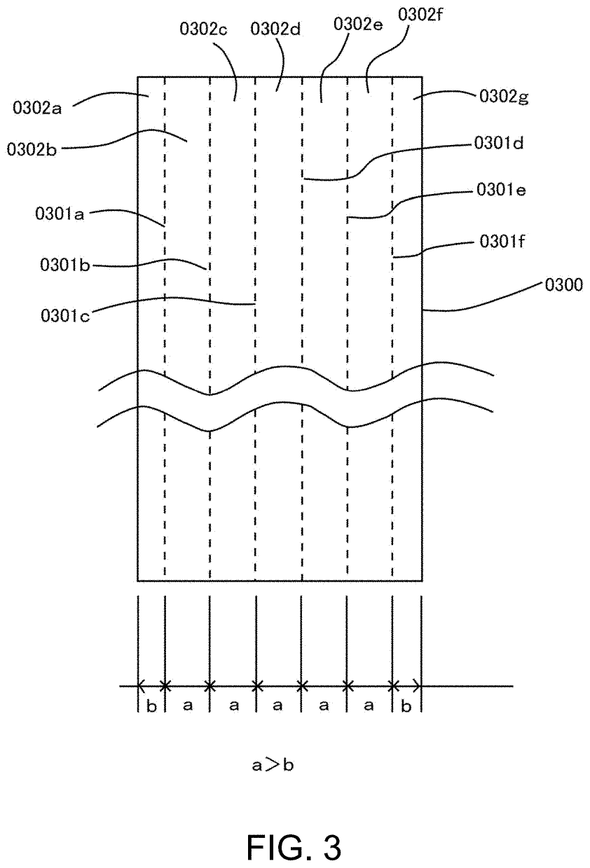

The frame is manufactured by bending (processing) a thin steel material (a frame main body) 0300 as shown in FIG. 3. Second to sixth strip-shaped plate parts 0302b to 0302f having substantially the same width are formed on the frame main body 0300 to be divided at equal intervals, except strip-shaped plate parts 0302a and 0302g located at both ends, by first to sixth folding lines 0301a to 0301f extending parallel to each other in the longitudinal direction. The strip-shaped plate parts 0302a and 0302g have a structure having a width narrower than that of the other strip-shaped plate parts 0302b to 0302f (a>b shown in FIG. 3). This is to secure a gap when each of the frames are cross-connected. The first, second, fifth, and sixth folding lines 0301a, 0301b, 0301e, and 0301f are valley-folded and bent so that the first, third, fifth, and seventh strip-shaped plate parts 0302a, 0302c, 0302e, and 0302g are perpendicular to the remaining second, fourth, and sixth strip-shaped plate parts 0302b, 0302d, and 0302f, and the remaining third and fourth folding lines 0302c and 0302d are mountain-folded and bent.

### First Embodiment, Shape of Completed Building Frame

The completed frame main body has a channel structure in which the center portion (the connection part) is formed between the substantially U-shaped parts 0101 in section. In the specification, the surface of the building frame having two grooves will be described as the front surface, and the surface thereof having one groove will be described as the back surface. A length of the building frame may have various lengths and may be, for example, 2.4 m, 2.7 m, 3.0 m, 6.0 m or longer. In the completed frame, a concrete flow hole may be appropriately provided for cases in which concrete spills out. Alternatively, a bolt hole or the like for a cross-connection part may be provided in advance for a case that the building frame is used as a building frame structure which will be described later. The building frame has an advantage that, when concrete is used for a building panel structure or the like to form a structural member composited with concrete, a contact area with concrete becomes larger, compared with a reinforcing bar having the same cross sectional area. Therefore, there is an advantage that an amount of the metal material required to form a structure having the same strength as that of a reinforced concrete one can be reduced, and thus a weight of the structural member can be further reduced.

### Second Embodiment

### <Outline of Second Embodiment>

A second embodiment is based on the first embodiment and has a configuration in which the building frames are disposed in a longitudinal direction and a transverse direction and have cross-connection parts which intersect each other.

### <Configuration of Embodiment>

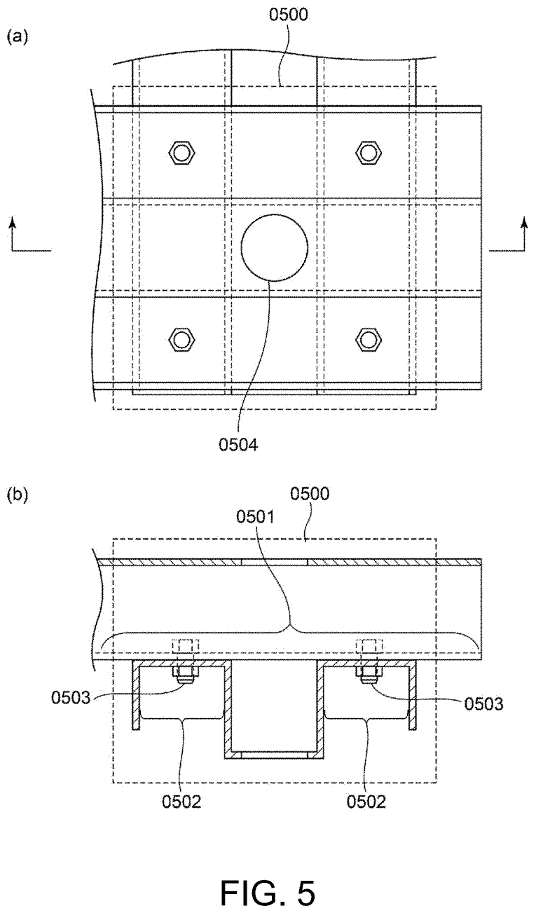

As shown in FIGS. 4A, 4B, and 4C, a building frame structure 0400 of the second embodiment has a cross-connection part 0401 which cross-connects the building frames of the first embodiment. Further, as shown in FIG. 5, a cross-connection part 0500 is configured using a rod-shaped body 0503 which penetrates and fixes a straight portion 0501 of one building frame and a straight portion 0502 of another building frame.

### <Explanation of Configuration of Embodiment>

### <Explanation of Configuration of Second Embodiment, Cross-Connection Part>

The “cross-connection part” 0401 (0500) cross-connects the building frames. The building frame structure 0400 shown in FIGS. 4A, 4B, and 4C shows an example of cross-connection by assembling the frames (front and back) shown in FIG. 2. Assuming that the surface of the building frame described in the first embodiment having two grooves is the front surface and the surface thereof having one groove is the back surface, there are three types of combinations of connection surfaces at the cross-connection part including a combination of the front surface and the front surface, a combination of the back surface and the front surface, and a combination of the back surface and the back surface. In one building frame structure, it is not always necessary that the cross-connection part is configured of only one of the combinations. For example, building frames which are repeatedly arranged in parallel may be disposed in order of the front surface, the back surface, the front surface, and the back surface, and building frames which are connected to and intersect them may also be disposed in order of the back surface, the front surface, the back surface, and the front surface. Each of the “straight portions” 0501 and 0502 is formed in a straight line to connect the building frames. This is because when they are not connected through the straight portion, a coupling force between the frames will be insufficient, and there is a risk of collapse, or the like.

### <Explanation of Configuration of Second Embodiment, Rod-Shaped Body>

The “rod-shaped body” 0503 penetrates and fixes the straight portion of one building frame and the straight portion of another building frame. Although nuts and bolts are illustrated for the rod-shaped body 0503 in FIG. 5, the present invention is not limited thereto, and the frames may be fixed to each other with fixing screws, rivets, drill screws, or the like.

### <Explanation of Configuration of Second Embodiment, Penetrating and Fixing>

“Regarding the penetrating and fixing,” the straight portion 0501 and the straight portion 0502 of the two frames are penetrated and fixed. The frames are penetrated and fixed to be coupled to each other with high strength. In a narrow place in which construction work is performed, drill screws may be fixed using a drill. The fixing may be performed by welding or the like. In order to improve this welding which is performed, arc welding using a robot or the like may be performed. This arc welding includes consumable electrode type welding in which an electrode melts, becomes droplets and then transfers to a base material, and non-consumable electrode type welding in which an electrode does not melt and a filler metal (a welding rod) is sent to a molten pool and melted into a base metal. In the former case, the above-described holes are formed in the cross-connection parts of the building frames, and the building frames exposed in the holes are welded to each other. In the latter case, electrodes are applied to the straight portions from the front and back surfaces, and welding is performed. In the cross-connection part 0500 of FIG. 5, penetrating and fixing is performed using four bolts and nuts, but when there is no problem with strength, the number of bolts and nuts may be reduced.

### Second Embodiment, Others, Cross-Connection Pattern 1

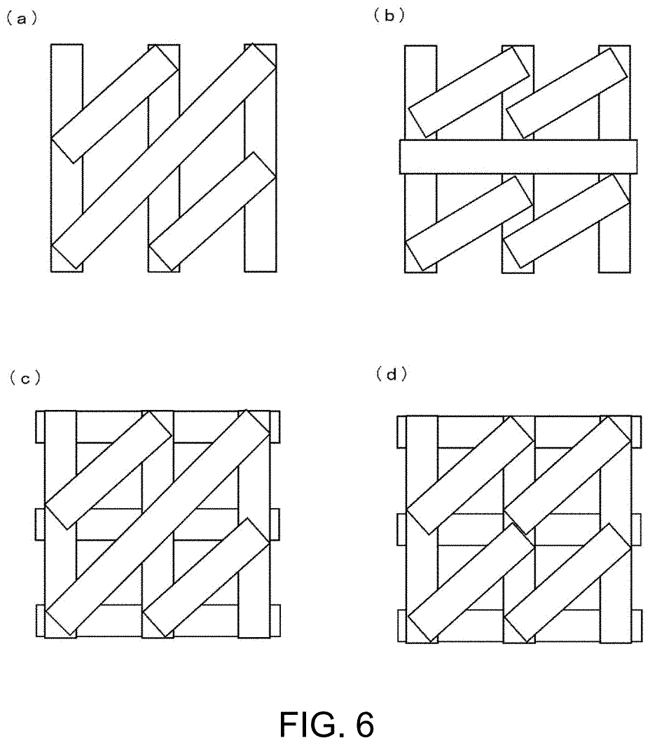

As shown in (a) of FIG. 6, the frames are doubly cross-connected, and the frames in the transverse direction are cross-connected diagonally with respect to the longitudinal direction of the frame.

### Second Embodiment, Others, Cross-Connection Pattern 2

As shown in (b) of FIG. 6, the frames are doubly cross-connected, and with respect to the longitudinal direction of the frame, one frame in the transverse direction intersects at a substantially right angle in the center, and upper and lower two frames intersect diagonally.

### Second Embodiment, Others, Cross-Connection Pattern 3

As shown in (c) of FIG. 6, the frames are triply cross-connected, and with respect to the longitudinal direction of three frames, three frames in the transverse direction intersect at equal intervals, and three frames further intersect diagonally.

### Second Embodiment, Others, Cross-Connection Pattern 4

As shown in (d) of FIG. 6, the frames are triply cross-connected, and with respect to the longitudinal direction of three frames, three frames in the transverse direction intersect at equal intervals, and four frames further intersect diagonally.

As shown in FIG. 2, a hole for concrete injection may be provided in the connection part of the frame. This hole may be provided at all intersections or at selected intersections. Thus, it is possible to reduce a time it takes for concrete to enter through this hole and to be distributed to the entire frame structure. In FIG. 6, although the cross-connection is illustrated as an in-plane cross-connection, not only the in-plane cross-connection, but also the building frame which performs the cross-connection in a direction perpendicular to a paper surface of the drawing may be added to perform three-dimensional cross-connection, and thus the building frame structure may be formed. In this case, it is preferable that the building frame which is cross-connected in the direction perpendicular to the paper surface of the drawing be also connected via the straight portion and the straight portion. Further, the building frame structure shown in FIG. 6 may be configured to be mixed and included in one building frame structure. For example, it may be mixed so that a first layer is (a), a second layer is (b), a third layer is (c), and a fourth layer is (d).

### Third Embodiment

### <Outline of Third Embodiment>

A third embodiment is based on the first and second embodiments and constitutes a building panel structure in which a wall panel which covers a main surface is disposed on the building frame structure of the second embodiment in a contact manner or a non-contact manner.

### <Configuration of Third Embodiment>

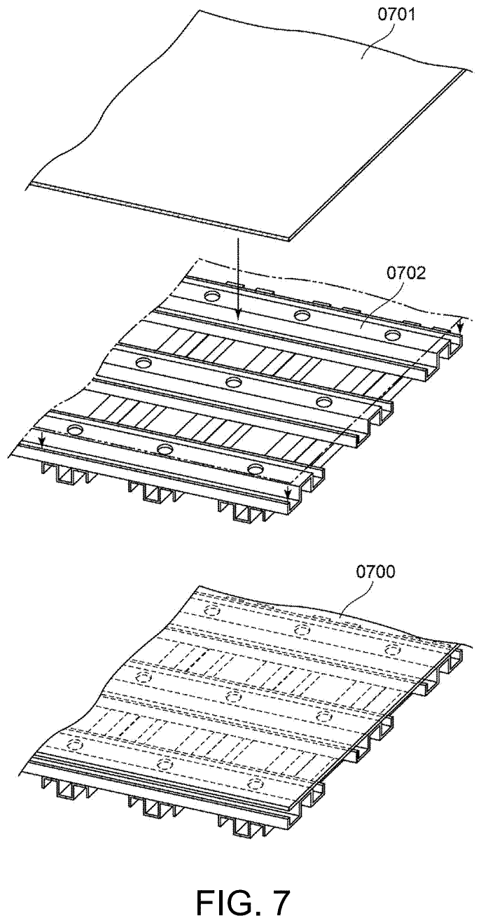

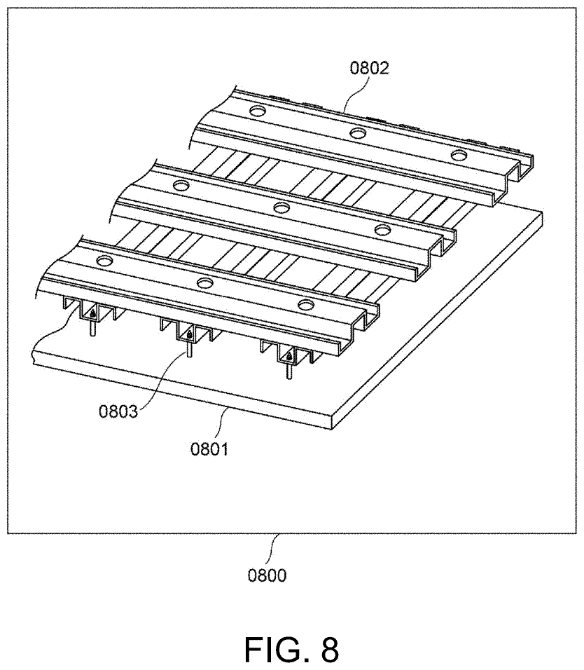

As shown in FIG. 7, a building wall panel structure 0700 of the third embodiment constitutes a building panel structure in which a wall panel 0701 which covers the main surface is disposed on the building frame structure 0702 of the second embodiment in a contact manner. Further, as shown in FIG. 8, a building wall panel structure 0800 of the third embodiment constitutes a building panel structure in which a wall panel 0801 which covers the main surface is disposed on the building frame structure 0802 of the second embodiment in a non-contact manner.

### <Explanation of Configuration of Third Embodiment>

### <Explanation of Configuration of Third Embodiment, Wall Panel>

As shown in FIG. 7 or 8, the “wall panels” 0701 and 0801 are configured of a thin concrete panel or the like. The concrete panel has a thickness of, for example, about 6 mm. Plywood may be used instead of the concrete panel. At this time, the wall panel can be removed as described later after the construction is completed. Further, so-called new building materials may be used. These new building materials include heat insulating materials such as styrene and urethane, simple board materials such as vinyl chloride and polyester, decorative boards, plastic flooring materials, and the like. A glass plate, a ceramic plate, or two or more composite materials such as styrene, urethane, vinyl chloride, polyester, glass, and ceramics may be used. Although it is referred to as the wall panel in the present application, the present invention is not necessarily limited to a wall surface application and can be used for various surfaces such as floor surfaces, ceiling surfaces, staircase surfaces, and roof surfaces.

### <Explanation of Configuration of Third Embodiment, Installation of Wall Panel: Main Surface>

In the specification, the “main surface” is a concept defined in relation to the building frame structure and refers to a surface of which a normal axis is a center normal axis of a space surface surrounded by the building frame formed by the cross-connection part of the building frame structure. Specifically, the surface is configured of a plane that commonly includes a straight portion of a convex region on the repeated front or back surfaces of building frames that are disposed parallel to each other and repeatedly disposed on a building frame structure, or a plane parallel thereto.

The wall panels 0701 and 0801 are installed to cover the main surface and are attached by fixing screws 0803, bolts and nuts, drill screws, or the like, and in some cases, by an adhesive, double-sided tape, or the like.

<Explanation of Configuration of Third Embodiment, Regarding Configuration in Contact with Building Frame Structure>

The “contact configuration” is a configuration in which the wall panel is in direct contact with and fixed to the building frame constituting the building frame structure. That is, the wall panel is fixed to the building frame in a contact region. The main surface of the building frame structure may be divided into the front side and the back side, but it is not always necessary that both sides are in direct contact, and as long as any one is configured to be in direct contact, it corresponds to the building panel structure referred to in the embodiment. An advantage of this direct contact configuration is that the wall panel can be relatively easily fixed. This is because when the wall panel is fixed in a non-contact manner, it is necessary to adjust a gap between it and the building frame structure. Further, although when the wall panel is a contact type, there is a problem that an insert, for example, a heat insulating material or a soundproofing material cannot be disposed with a sufficient thickness between the wall surface and the building frame structure, there is also a method of increasing a volume of the insert disposed under the wall surface by the building frame structure being formed by making the building frame constituting the building frame structure have three or more layers.

<Explanation of Configuration of Third Embodiment, Non-Contact with Building Frame Structure>

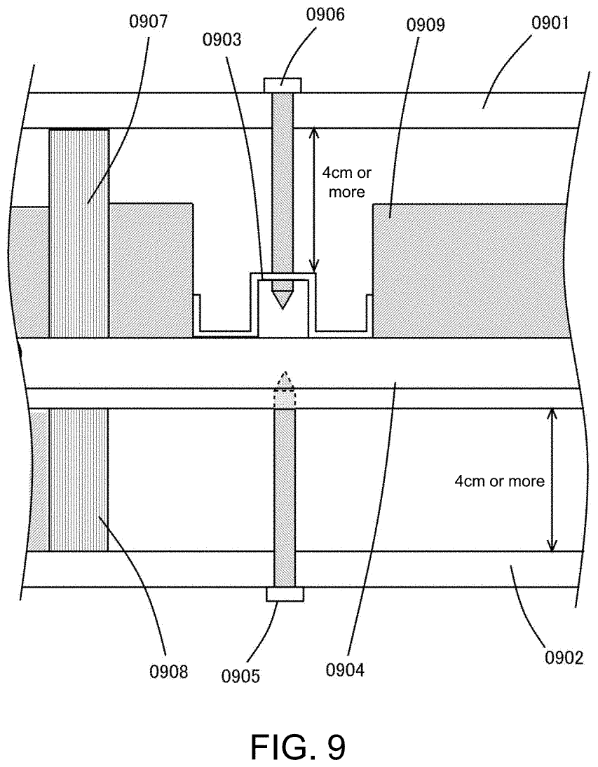

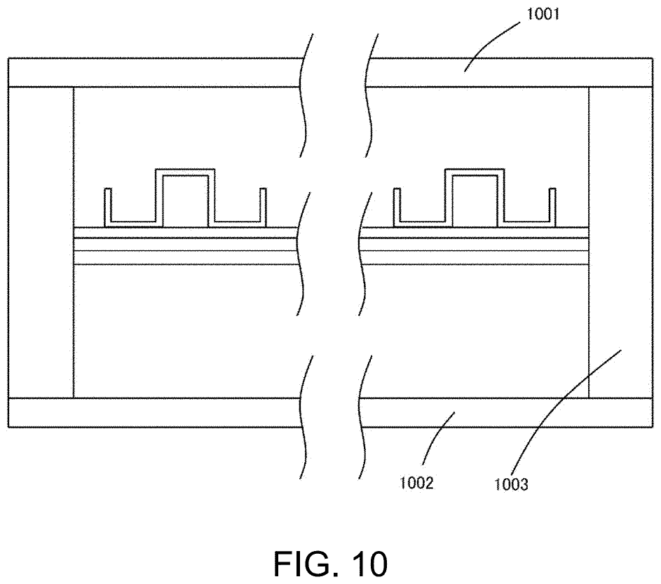

When the main surface is covered with the wall panel in a non-contact manner in the building frame structure, a wall panel 0901 and a building frame 0903, and a wall panel 0902 and a building frame 0904 are fixed with screws 0905 and 0906, as shown in FIG. 9. Further, the building frame 0903 and the building frame 0904 are cross-connected to each other. Spacers 0907 and 0908 may be provided to provide a predetermined gap between the both building frames cross-connected to each other and the wall panels 0901 and 0902 disposed therein in a non-contact manner. A heat insulating material 0909 can be disposed between the building frame 0903 and the building frame (not shown) disposed parallel to and adjacent to each other in the same stage by a spacer 0907. Further, as shown in FIG. 10, a wall panel 1001 and a wall panel 1002 may be maintained at a predetermined gap using a spacer 1003.

### Third Embodiment, Configuration of Other Frame Structures

As shown in (a), (b), (c), and (d) of FIG. 2, (the drawing is illustrated with an actual frame length reduced for ease of understanding. In reality, a ratio of the width to the length of the frame is about 10 times or more and 100 times or less. When it is smaller than 10 times, the assembly efficiency will be lowered, and the strength will be over-engineered, and when it is larger than 100 times, the strength will be insufficient. A plurality of combination patterns can be realized to produce a framework using the building frames 0200a, 0200b, 0200c, and 0200d of the present invention as the front and back surfaces. The lengths of the frames 0200a to 0200d will be described. For example, when a two-story building is constructed, a frame material having a length of about 5.8 m for a longitudinal frame and about 3.0 m for a horizontal frame is produced, and wall panels, floor panels, roof panels, or the like are assembled. A first floor portion of the longitudinal frame is about 3.0 m, and a second floor portion is about 2.8 m. For example, a building using one front panel, one back panel, four corner panels, two center panels, one floor panel, and one roof panel is 23.4 m² on the first floor and 23.4 m² on the second floor, and thus, a house having a total area of 46.8 m² is formed. As shown in the drawing, a round hole may be formed in the connection part other than the cross-connection part so that concrete can easily flow in, or a round hole may be configured not to be formed in all including the cross-connection part. Of course, locations of the round holes may be configured so that the above are mixed.

### Fourth Embodiment

### <Outline of Fourth Embodiment>

In the fourth embodiment, the heat insulating material is disposed in the frame space formed by the cross-connection parts of the building frame structure of the second embodiment, or the heat insulating material is disposed between the building frames of the building frame structure which are disposed parallel to and adjacent to each other. Further, in the fourth embodiment, a heat insulating material is disposed between the building frame of the building frame structure and the wall panel.

### <Configuration of Fourth Embodiment>

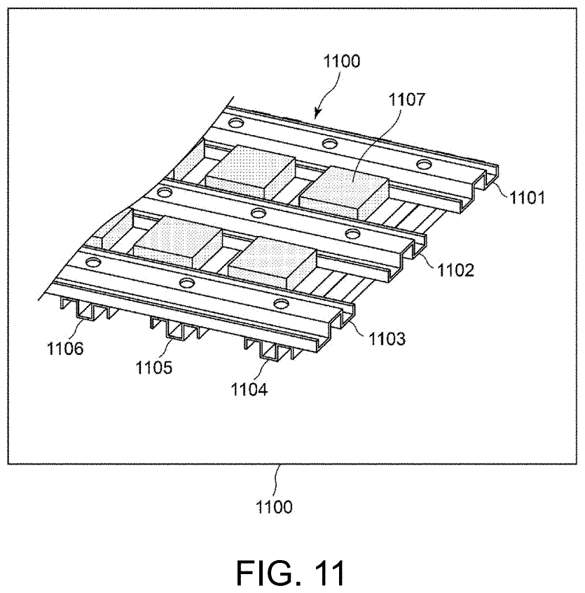

As shown in FIG. 11, a building panel structure 1100 of the fourth embodiment is a building panel structure in which a heat insulating material 1107 is disposed in a frame space formed by the cross-connection parts in a building frame structure in which building frames 1101, 1102, and 1103 located at an upper stage and building frames 1104, 1105, and 1106 located at a lower stage are cross-connected by the cross-connection parts in the drawing.

### <Explanation of Configuration of Fourth Embodiment>

### <Explanation of Configuration of Fourth Embodiment, Heat Insulating Material>

The heat insulating material may be appropriately selected according to intended use and usage environment of the building panel structure, and for example, board-shaped urethane foam or polystyrene foam as shown in FIG. 11 can be used. Further, although not shown, a fiber-based heat insulating material such as glass wool or rock wool may be used in place of the board-shaped heat insulating material or in combination with the board-shaped heat insulating material.

A thickness of the board-shaped heat insulating material is about 80 mm to 320 mm, and a suitable thickness may be used in consideration of a thickness of the building frame and the like. In addition, when a fiber-based heat insulating material is used, since it is effective to squeeze and place it in the frame space in order to enhance a heat insulating effect, it is preferable to use a heat insulating material having a thickness larger than the thickness of the building frame constituting the frame space disposed in an unpressed state.

Further, it is also preferable to dispose not only the heat insulating material but also materials exhibiting effects such as a soundproofing effect, a flameproofing effect, and a flame retardant effect together with or mixed with the heat insulating material. When the materials which exhibit multiple types of effects as described above are disposed together, the heat insulating materials having different effects may be disposed according to locations of a plurality of frame spaces configured by the cross-connection parts present in the building panel structure.

### <Explanation of Configuration of Fourth Embodiment, Arrangement of Heat Insulating Material in Frame Space Configured by Cross-Connection Parts>

Preferably, the heat insulating material is disposed not to impair the heat insulating effect. For example, when the board-shaped heat insulating material is disposed, preferably, the heat insulating material is cut to approximately the same size as that of the frame space, and a gap between the building frame to be the frame and the heat insulating material is covered with a moisture-proof tape or the like. Further, when a plurality of heat insulating materials is disposed in a plurality of frame spaces as shown in FIG. 11, preferably, a sheet is attached to cover all the heat insulating materials. An aspect of covering with a sheet is particularly preferable when a fiber-based heat insulating material with which it is difficult to individually cover gaps in the frame is used.

### <Explanation of Configuration of Fourth Embodiment, Arrangement of Heat Insulating Material Between Building Frames Disposed Parallel to and Adjacent to Each Other>

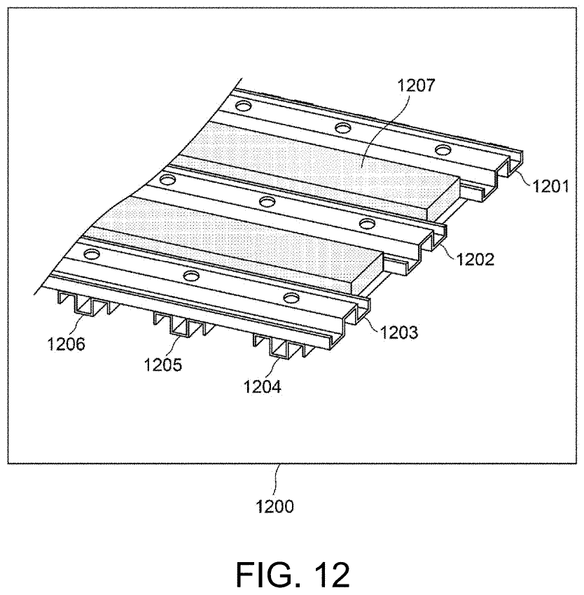

FIG. 12 shows a building panel structure 1200 in which the heat insulating material is disposed between the building frames of the building frame structure which are disposed parallel to and adjacent to each other. As shown in the drawing, three building frames 1201, 1202, and 1203 located at the upper stage are disposed parallel to each other to be cross-connected to building frames 1204, 1205 and 1206 located at the lower stage. Then, a heat insulating material 1207 is disposed between the building frame 1202 located at the center and the building frame 1201 located at one end, and similarly, a heat insulating material is also disposed between the building frame 1202 located at the center and the building frame 1203 located at the other end.

In the building panel structure of the aspect, the heat insulating material is disposed as shown in the drawing, and the heat insulating material may be disposed between the building frame 1204 and the building frame 1205 disposed parallel to and adjacent to each other at the lower stage and also between the building frame 1205 and the building frame 1206. This is preferable because in this case better heat insulating effects can be obtained.

### <Explanation of Configuration of Fourth Embodiment, Arrangement Between Building Frame and Wall Panel>

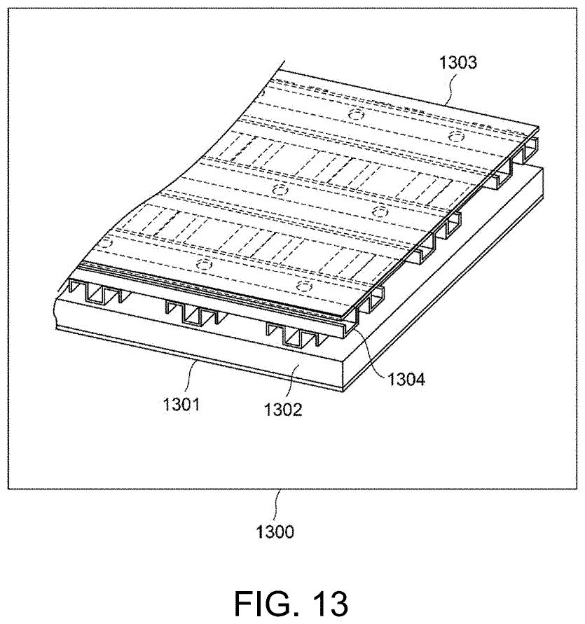

FIG. 13 shows a building panel structure in which a wall panel which covers the main surface is disposed on a building frame structure in a non-contact manner and in which the heat insulating material is disposed between the building frame and the wall panel.

As shown in the drawing, in a building panel structure 1300, a wall panel 1303 is disposed on the building frame structure 1303 in a contact manner, and the wall panel 1301 is disposed at a position, at which it faces the wall panel 1303, on the building frame structure 1303 in a non-contact manner. A heat insulating material 1302 is adhered to the wall panel 1301 in advance, and a predetermined gap can be easily provided between the wall panel and the building frame structure by screwing the wall panel 1301 and the building frame structure 1303 in that state. Further, in some cases, a gap between the wall panel 1301 and the building frame structure 1303 may be set according to a length of a screw (not shown in the drawing) for installing the wall panel 1301 on the building frame structure 1303 in a non-contact manner, the heat insulating material is disposed to fill the gap, and thus the heat insulating material 1302 can be disposed over the entire surface of the wall panel 1303. Furthermore, it is also possible to adopt a construction method in which the gap is set by fixing the wall panel directly to the building frame structure and disposing another wall panel parallel to the wall panel in a non-contact manner by screwing or the like, and a heat insulating layer is set by pouring polyurea or a fluid heat insulating material mixed with a heat insulating material into the gap.

### Fourth Embodiment, Others, Regarding Gap Between Heat Insulating Material and Wall Panel

The gap between the building frame and the wall panel will be described with reference to FIG. 9. This gap can be appropriately determined according to required specifications and performance, and for example, when a building panel structure is used in a cold region, preferably, the gap between the building frame 0903 and the wall panel 0901 is 40 mm or more, as shown in the drawing. When concrete is filled in the gap, performance is guaranteed so that the strength of the building is not insufficient even when the wall surface is continuously heated with a flame for 2 hours. When a wall surface heating time is 1 hour, the gap may be 10 mm after the concrete filling. Of course, after the concrete filling, the gap may be between 10 mm and 40 mm and may be 40 mm or more. The same applies to the gap between the building frame 0904 and the wall panel 0902. This is because it is possible to simply secure a space for disposing the heat insulating material 0909 which can sufficiently achieve the heat insulating performance required in a cold region by having such a gap. The heat insulating material may be disposed in a lower space.

### Fifth Embodiment

### <Outline of Fifth Embodiment>

The fifth embodiment is based on the building panel structure of the third embodiment and is a building panel structure in which concrete is filled between wall panels including the U-shaped parts of the building frame.

### <Configuration of Fifth Embodiment>

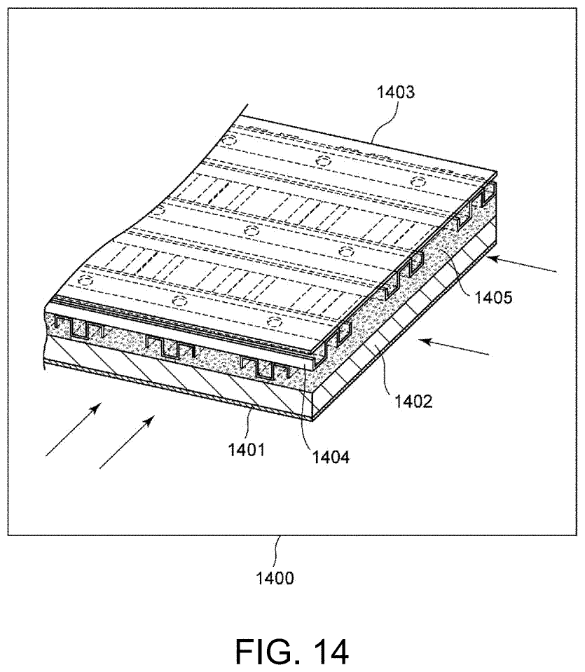

FIG. 14 is a diagram showing an example of a building panel structure of the embodiment. As shown in the drawing, a building panel structure 1400 is configured of a building frame structure 1404 on which a wall panel 1403 is disposed in a contact manner, and a wall panel 1401 disposed on the building frame structure in a non-contact manner, and also, concrete 1405 is filled between the wall panel 1401 and the wall panel 1402 with a heat insulating material 1402 interposed therebetween. Further, as will be described later, even when concrete is filled in different directions shown in the drawing, concrete is filled in every corner between the wall panels, and concrete is quickly and thoroughly filled inside a groove provided by a bent structure of the building frame.

### <Explanation of Configuration of Fifth Embodiment>

### <Explanation of Configuration of Fifth Embodiment, Concrete Filling>

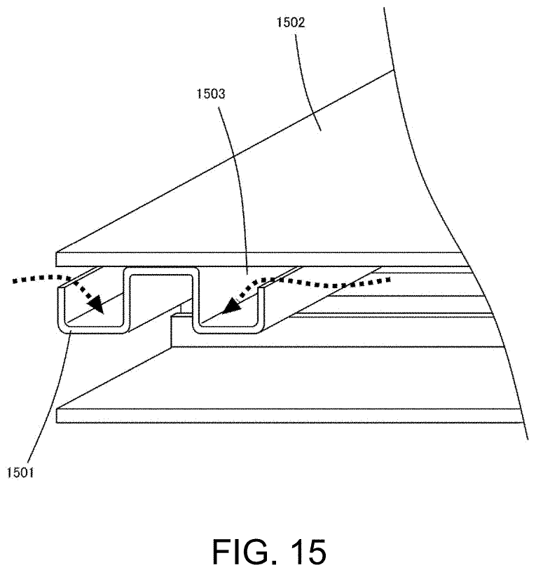

A mechanical strength of the building panel structure is increased and usefulness as a structural member is improved by filling concrete between the wall panels. Further, a unique action of using the building frame will be explained with reference to FIG. 15. As shown in the drawing, since a building frame 1501 has a feature that a longitudinal piece on the side away from the center portion of the U-shaped part is shorter than a longitudinal piece on the center side, even when a wall panel 1502 is disposed on the building frame 1501 in a contact manner, a gap is generated between an end portion of the longitudinal piece of the U-shaped part on the side away from the center portion and the disposed wall panel 1502. As shown by dotted arrows in the drawing, so-called ready-mixed concrete (freshly mixed concrete) before solidification flows into the inside of the groove formed by the left and right U-shaped parts from the gap. Therefore, it has an excellent effect that even in a situation in which it is difficult for ready-mixed concrete to flow, such as a case in which the wall panels sandwiches the building frame structure formed by connecting building frames longitudinally and horizontally, concrete is filled in every corner between the facing wall surfaces, and also due to the cross-sectional shape which is bent many times, concrete spreads quickly and thoroughly inside the grooves of which opening directions are opposite to each other. Although various types of concrete can be used for filling, a particle size of sand or the like contained in the concrete must be a certain size or less in order for the building frame to be sufficiently surrounded by concrete. More specifically, the particle size needs to be sufficiently smaller than a length b-a shown in FIG. 1. For example, the particle size is about 1 mm to 2 mm.

### <Explanation of Configuration of Fifth Embodiment, Filling Method>

Concrete filling between wall panels can be performed by a known method, not by a specific method. For example, after a formwork in which the ready-mixed concrete that has flowed into the wall panels is prevented from leaking out is assembled, the ready-mixed concrete flows in a space between the wall panels. At this time, preferably, the inflow of the ready-mixed concrete is performed while vibration is applied so as not to generate air bubbles. Further, more preferably, the applying of vibration continues for a while after the inflow.

### <Explanation of Configuration of Fifth Embodiment, Filling Between Wall Panels and Using Wall Panels as Indoor Inner Walls>

The wall panels can be used on both outer and inner walls of a building. Here, it is preferable to dispose a large amount of heat insulating material on the wall panel to be used as the outer wall in order to increase energy efficiency of heating and cooling. On the other hand, since it is sufficient to dispose a relatively small amount of heat insulating material on the wall panel to be used as the inner wall, it is possible to obtain a wall panel having a restricted thickness, and this contributes to curbing an occupied space of the wall panel for the inner wall in a space inside the building.

### Fifth Embodiment, Location Patterns 1 to 4 of Filled Concrete in Relation to Wall Surface and Heat Insulating Material

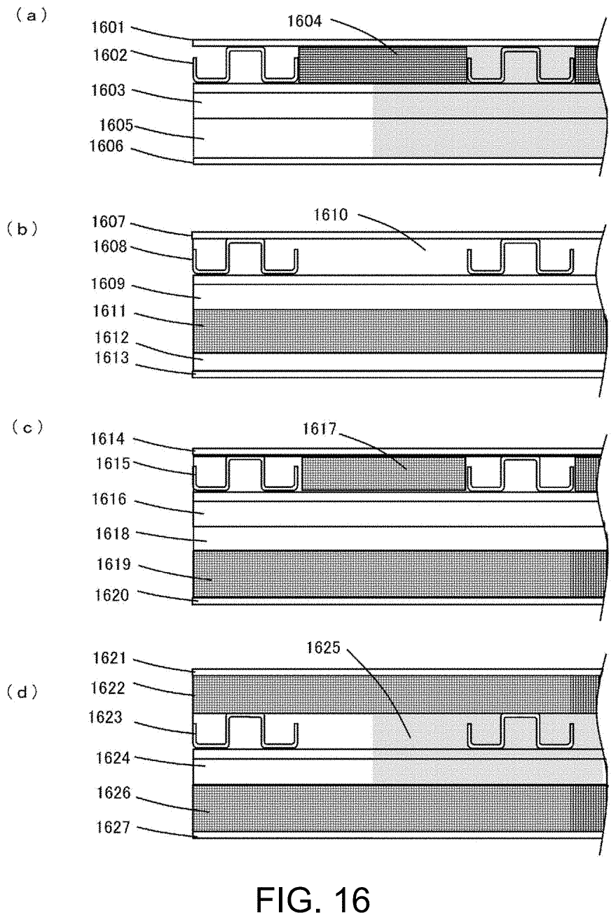

The concrete filling between the wall panels can be performed in various ways. FIG. 16 shows some aspects thereof with a sectional view of a building panel structure. A building panel structure shown in (a) of FIG. 16 is a cross-connected structure of a building frame 1602 (there are other building frames disposed parallel thereto, it is the same as below) and a building frame 1603 (there are other building frames disposed parallel thereto, it is the same as below). A wall panel 1601 is directly disposed on the building frame in the upper portion of the drawing. Additionally, 1604 such as a heat insulating material is disposed in a part therebetween. A wall panel 1606 is disposed on the building frame 1603 in non-contact manner in the lower portion of the drawing, and concrete 1605 (a region shown in gray in the drawing) is evenly filled and solidified between the upper wall panel 1601 and the lower wall panel 1606 except for portions of the building frame and the heat insulating material.

A building panel structure shown in (b) of FIG. 16 is a cross-connected structure of a building frame 1608 (there are other building frames disposed parallel thereto, it is the same as below) and a building frame 1609 (there are other building frames disposed parallel thereto, it is the same as below). A wall panel 1607 is directly disposed on the building frame in the upper portion of the drawing. Additionally, a wall panel 1613 is disposed on the building frame 1609 in a non-contact manner in the lower portion of the drawing, and a heat insulating material 1611 is disposed on the building frame in a contact manner with in the lower portion of the drawing. Further, a wall panel 1613 on the lower side in the drawing is disposed on the heat insulating material 1611 in a non-contact manner. Concrete 1612 is filled and solidified in a region of the non-contact arrangement. On the other hand, concrete 1610 (a region shown in gray in the drawing) is filled between the wall panel 1607 disposed on the building frame in the upper portion of the drawing and the above-described heat insulating material 1611, and concrete is evenly filled and solidified between the heat insulating material and the wall panel 1607 which is in direct contact with the building frame in the upper portion of the drawing except for a portion of the building frame.

A building panel structure shown in (c) of FIG. 16 is a cross-connected structure of a building frame 1615 (there are other building frames disposed parallel thereto, it is the same as below) and a building frame 1616 (there are other building frames disposed parallel thereto, it is the same as below). A wall panel 1614 is directly disposed on the building frames in the upper portion of the drawing, and a heat insulating material 1617 is disposed above a building frame in the lower portion of the drawing between the building frames disposed parallel to each other on the upper portion of the drawing. Additionally, a wall panel 1620 in which a heat insulating material 1619 is directly disposed on the building frame side is disposed on the building frame 1616 in the lower portion of the drawing in a non-contact manner. Concrete is filled between the heat insulating material 1619 and the wall panel 1614 directly disposed on the building frame 1615 in the upper portion of the drawing, and the concrete 1618 (a region shown in gray in the drawing) is evenly distributed and solidified in the portions except for the heat insulating material 1617 disposed between the building frames in the upper portion of the drawing and the building frame structure.

In a building panel structure shown in (d) of FIG. 16, a building frame structure is configured by the cross-connection between a building frame 1623 (there are other building frames disposed parallel thereto, it is the same as below) and a building frame 1624 (there are other building frames disposed parallel thereto, it is the same as below). One in which 1622 such as a heat insulating material is directly disposed on a wall panel 1621 is disposed on the building frame, which faces the heat insulating material, on the upper side in the drawing. The heat insulating material and the building frame in the upper portion of the drawing are in direct contact with each other. Similarly, a wall panel 1627 is directly disposed on the building frame 1624 in the lower portion of the drawing to face a heat insulating material 1626. Then, concrete is filled between the upper heat insulating material 1622 and the lower heat insulating material 1626, and concrete 1625 (a region shown in gray in the drawing) is evenly distributed and solidified over a region except for the building frame structure. The wall panel described in the embodiment may be a decorative plate used for an actual interior or exterior, or may be a formwork material used for allowing concrete to flow in a construction process. Further, the upper side in each of the drawings may be the room side or the upper side may be the outside. Further, the wall surface may be formed by arbitrarily combining (a) to (b) of FIG. 16. Although the configuration in which concrete is filled in the building panel structure using a part of the heat insulating material has been described, it is not always necessary to use the heat insulating material, and the concrete may be filled in the building panel structure without using the heat insulating material. Further, instead of or in addition to the heat insulating material, a soundproofing material, a sound insulation material, a fireproof material, other structural members and the like may be used.

### Sixth Embodiment

### <Outline of Sixth Embodiment>

A sixth embodiment is a building panel structure in which the wall panel is removed from the building panel structure of the fifth embodiment.

### <Configuration of Sixth Embodiment>

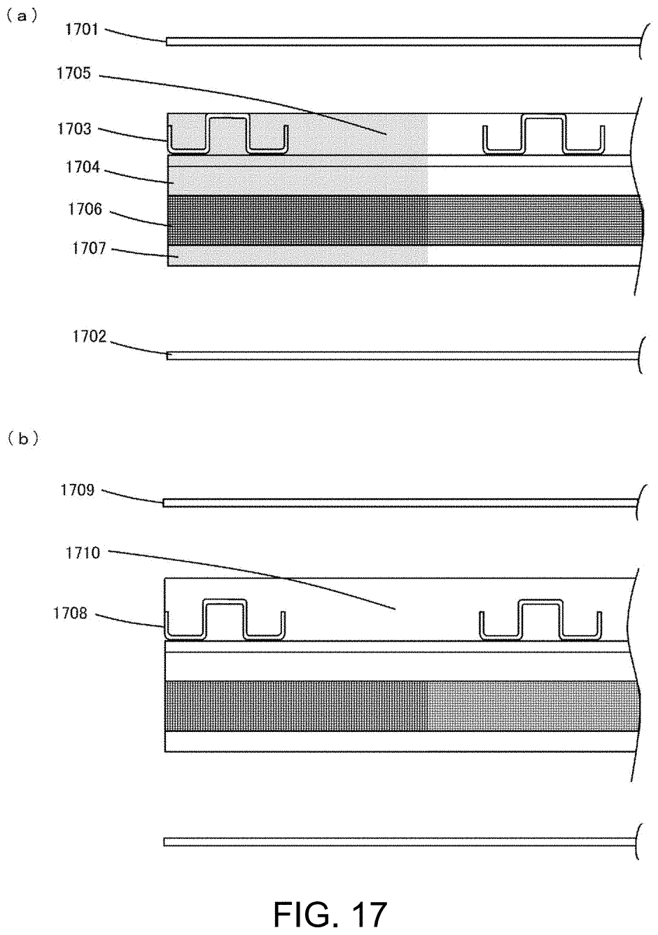

(a) of FIG. 17 shows a cross-sectional view of an example of a building panel structure according to the sixth embodiment. This building panel structure is obtained by removing the wall panel of the building panel structure shown in (b) of FIG. 16 in the fifth embodiment. In the following description of (a) of FIG. 17, the building panel structure of the fifth embodiment may be referred to as an “original building panel structure”.

As shown in the drawing, wall panels 1701 and 1702 which have been originally disposed are removed, and a building frame structure formed by cross-connections of a plurality of building frames at the upper and lower portions including a cross-connection between a building frame 1703 and a building frame 1704 is set as a result to be configured of concrete 1705 consequently containing by solidification, a heat insulating material 1707 disposed below the building frame structure, and concrete 1707 disposed on the lower side.

### <Explanation of Configuration of Sixth Embodiment>

### <Explanation of Configuration of Sixth Embodiment, Removal of Wall Panel (Formwork)>

As described in the fifth embodiment, the building panel structure which is filled with concrete is embodied in various embodiments. As shown in (a) of FIG. 17, when the original building panel structure is configured by concrete being filled therein to be in contact with both wall panels and being solidified, a surface formed by the concrete is a main outer shell surface of the building panel structure. The building panel structure of which the main outer shell surface is concrete is preferable because it has a building frame structure as a framework and has a solid structure in which a heat insulating material is contained.

As described above, it can be said that the wall panel has a function as a formwork for making a concrete panel which has a building frame structure as a framework.

Also, in the original building panel structure, when one wall panel is in contact with concrete, and the other wall panel is in contact with a heat insulating material, only the wall panel which is in contact with concrete may be removed, and the other wall panel may be left as it is. The wall panel which is in contact with the heat insulating material may also be removed. In this case, a sufficient bonding force between the heat insulating material and concrete is required. Further, in some cases, a through hole may be provided in a part of the heat insulating material so that the lower concrete 1707 and the upper concrete 1705 may be connected through the hole. Then, the concrete on the lower side can be firmly fixed.

### <Explanation of Configuration of Sixth Embodiment, Removing Method>

In the removing of the wall panel, the wall panel may be removed after screws for disposing the wall panel on the building frame, or the like are removed, and in the case of a wall panel made of a relatively fragile material such as plywood, the wall panel may be cracked and removed.

<Explanation of Configuration of Sixth Embodiment, Work after Removal>

When concrete becomes the outer shell surface in the building panel structure from which the wall panel is removed, the concrete surface may be left exposed, and an agent for curbing occurrence of cracks or damage on the surface of concrete may be applied, or a sheet having the curbing effect may be attached.

### Six Embodiment, Another Example

(b) of FIG. 17 is another example of the sixth embodiment. In the previous example, since the building frame is partially exposed in the upper concrete, when it is required to make the entire wall surface concrete, a building frame 1708 in the upper portion of the drawing and the upper wall panel 1709 are not in contact with each other so that the building frame is not exposed on the wall surface, as shown in (b) of FIG. 17.

Thus, the entire wall surface can be made of concrete 1710. Other points are as described with reference to (a) of FIG. 17.

### Seventh Embodiment

### <Outline of Seventh Embodiment>

A seventh embodiment is based on any one of the third to sixth embodiments and is a building panel structure in which the building frame constituting the building panel structure is “a building frame characterized by including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view have the same length as longitudinal sides thereof, on a center side, connected by the connection part (it means almost the same length, and there may be a tolerance of about plus or minus 5%)” in place of or in addition to the building frame of the first embodiment.

### <Configuration of Seventh Embodiment>

The embodiment is a building panel structure in which the building frame is “a building frame characterized by including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view have the same length as longitudinal sides thereof, on a center side, connected by the connection part” in place of or in addition to “a building frame characterized by including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part”.

A structural difference between the building frame of the first embodiment and the building frame which is “replaced or added” and becomes a part or whole of the configuration is that in the latter, the longitudinal sides, on the side away from the center portion, of the U-shaped parts disposed on the left and right sides in the cross-sectional view are shorter than the longitudinal sides, on the center side, connected by the connection part, and in the former, the longitudinal sides, on the side away from the center portion, of the U-shaped parts disposed on the left and right sides in the cross-sectional view have the same length as the longitudinal sides, on the center side, connected by the connection part. Therefore, the former building frame which is “replaced or added” and constitutes the building panel structure is referred to as a “building frame having the same length” for convenience of explanation.

The building frame having the same length is different from the building frame of the first embodiment only in the above-described one point. Therefore, the difference will be described below, and description of the configuration similar to the building freight of the first embodiment will be omitted.

### <Explanation of Configuration of Seventh Embodiment>

As shown in FIG. 1, in the building frame of the first embodiment, the length a of the longitudinal sides, on the side away from the center portion, of the U-shaped parts disposed on the left and right sides of the center space in the cross-sectional view is shorter than the length b of the longitudinal sides thereof, on the center side, connected by the connection part. On the other hand, in the building frame having the same length, the length a of the longitudinal sides, on the side away from the center portion, of the U-shaped parts disposed on the left and right sides of the center space in the cross-sectional view is the same as the length b of the longitudinal sides thereof, on the center side, connected by the connection part.

When the building frame having the same length which has such a structure is cross-connected with another building frame having the same length or the building frame of the first embodiment, not only the connection part but also end portions of the longitudinal pieces, on the side away from the center portion, of the U-shaped parts disposed on the left and right sides is in contact with a connection target. Therefore, a surface contact by the connection part and a line contact by the end portions of the longitudinal pieces occur with respect to the connection target, and thus the frames are cross-connected more firmly.

Moreover, not only when the frames are cross-connected, but also when the wall panel is disposed on the building frame structure in a contact manner, since a contact with the wall panel due to the line contact can be added, in particular, it is effective in improving the strength of the building panel structure in a mode in which the wall panel not only serves as a concrete-filling formwork but also is continuously used as the wall surface of the building panel structure.

### Seventh Embodiment, Mixed Pattern

The building panel structure of the embodiment can be configured by combining the building frame having the same length and the building freight of the first embodiment in an arbitrary ratio. This ratio may be determined according to various conditions such as specifications or performance required for the building panel structure, the total number of building frames which can be used for the building panel structure, properties of concrete to be filled, and building panel structures and a construction period in which they are used. For example, when it is required to manufacture a high-strength building panel structure with a small number of building frames, only the building frame having the same length or a large proportion thereof is used. Also, when concrete with low fluidity or concrete which is easily solidified is filled, the proportion of the building frame of the first embodiment in which concrete is more likely to flow in is increased, as described with reference to FIG. 15.

### Eighth Embodiment

### <Outline of Eighth Embodiment>

An eighth embodiment is based on any one of the third to sixth embodiments and is a building panel structure which is characterized in that the building frame of the first embodiment is used as a longitudinal member, and C-shaped, U-shaped, H-shaped, and L-shaped frames are used in place of or in addition to the building frame of the first embodiment as transverse members.

### <Configuration of Eighth Embodiment>

The building panel structure of the embodiment is a building panel structure in which “a building frame characterized by including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part” is used as a longitudinal member, and C-shaped, U-shaped, H-shaped, and L-shaped frames are used in place of or in addition to “a building frame characterized by including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part” as transverse members.

### <Explanation of Configuration of Eighth Embodiment>

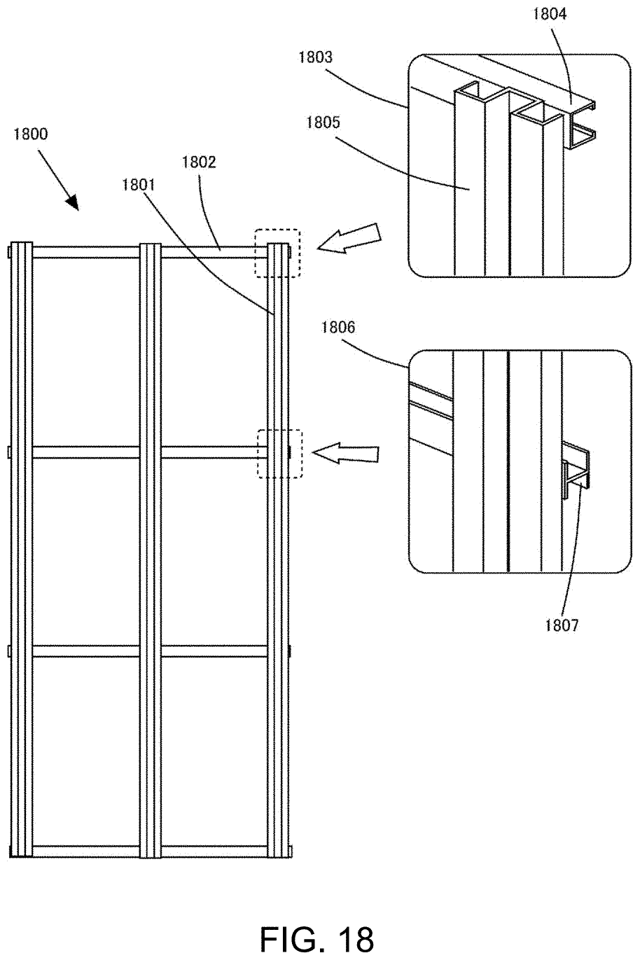

FIG. 18 is a conceptual diagram showing an example of a building panel structure of the embodiment. As shown in the drawing, a building panel structure 1800 is configured by longitudinally and horizontally combining three building frames as the longitudinal members and four frames 1802 as the transverse members.

The longitudinal member is a member in which a longitudinal direction of the member is planned to face in a substantially vertical direction when the building panel structure becomes a member constituting a building. Further, the transverse member is a member in which a longitudinal direction of the member is planned to face in a substantially horizontal direction when the building panel structure becomes a member constituting a building.

### <Explanation of Configuration of Eighth Embodiment, Longitudinal Member>

In FIG. 18, an up and down direction in the drawing corresponds to the vertical direction, and a left and right direction corresponds to the horizontal direction. As shown in a perspective view 1803 of a connection part between the longitudinal member and the transverse member (a portion surrounded by a dotted square in the drawing) at a corner of the building panel structure, “a building frame characterized by including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part” 1805 is used as the longitudinal member. Since this building frame is the building frame of the first embodiment, further description thereof will be omitted.

### <Explanation of Configuration of Eighth Embodiment, Conventional Frames (C, U, H, and L) are Transverse Members>

Further, in FIG. 1803 in the drawing, a C-shaped frame 1804 is used as the transverse member. Further, as shown in FIG. 1806 in the drawing showing a portion at which the longitudinal member and the transverse member intersect and are connected in a T shape, an H-shaped frame 1807 is used as the transverse member. In addition to the exemplified embodiment, only a frame of the same type may be used as the transverse member.

The building frame of the first embodiment used as the longitudinal member has higher strength than each of the frames listed as the transverse member. The longitudinal member bears the force of gravity applied to the building panel structure. It also bears an additional load to support floors and roofs upstairs. Therefore, a member having high strength is required, and the building frame of the first embodiment which can sufficiently meet such a demand is used.

On the other hand, the load that the transverse member should bear is smaller than that of the longitudinal member. Therefore, C-shaped, U-shaped, H-shaped, and L-shaped frames which can be lightweight and compact with respect to the building frame of the first embodiment are used.

### Ninth Embodiment

### <Outline of Ninth Embodiment>

A ninth embodiment is based on any one of the third to sixth embodiments and is a building panel structure in which the building frame constituting the building panel structure uses C-shaped, U-shaped, H-shaped, and L-shaped frames in place of or in addition to the building frame of the first embodiment.

### <Configuration of Ninth Embodiment>

The embodiment is a building panel structure in which the uses C-shaped, U-shaped, H-shaped, and L-shaped frames are used as the building frames in place of or in addition to “a building frame characterized by including U-shaped parts disposed on left and right sides so as to sandwich a center space in a cross-sectional view, and a connection part which connects top portions of the left and right U-shaped parts on a center side and thus constitutes a reverse U-shaped part, wherein longitudinal sides, on a side away from a center portion, of the U-shaped parts disposed on the left and right sides in a cross-sectional view are shorter than longitudinal sides thereof, on a center side, connected by the connection part”.

### <Explanation of Configuration of Ninth Embodiment>

In the building panel structure of the seventh embodiment, in the configuration, the building frame having the same length was used as the building frame constituting the building panel structure in place of or in addition to the building frame of the first embodiment. However, the embodiment is the building panel structure in which the C-shaped, U-shaped, H-shaped, and L-shaped frames are used in place of or in addition to the building frame of the first embodiment, in place of the building frame having the same length.

### <Explanation of Configuration of Ninth Embodiment, Frame is Conventional Type>

The C-shaped, U-shaped, H-shaped, and L-shaped frames have already been described in the eighth embodiment. Therefore, the repeated description thereof will be omitted.

### <Explanation of Configuration of Ninth Embodiment, Mixed Pattern>

Further, the use of the C-shaped, U-shaped, H-shaped, and L-shaped frames “in place of or in addition to” the building frame of the first embodiment is the same as the use of the building frame having the same length which is “replaced or added” in the seventh embodiment including the mode of use. Therefore, the repeated description thereof will be also omitted.

As described in the eighth embodiment, the C-shaped, U-shaped, H-shaped, and L-shaped frames are considered to be lighter, more compact, and cheaper than the building frame of the first embodiment. Therefore, construction can be performed at a reasonable cost and in a construction period using together the C-shaped, U-shaped, H-shaped, and L-shaped frames as appropriate according to specifications, performance, cost, construction period, and other conditions required for the building panel structure.

### Tenth Embodiment

### <Outline of Tenth Embodiment>

The tenth embodiment is a method for constructing a building using the building frame structure of the second embodiment.

### <Configuration of Tenth Embodiment>

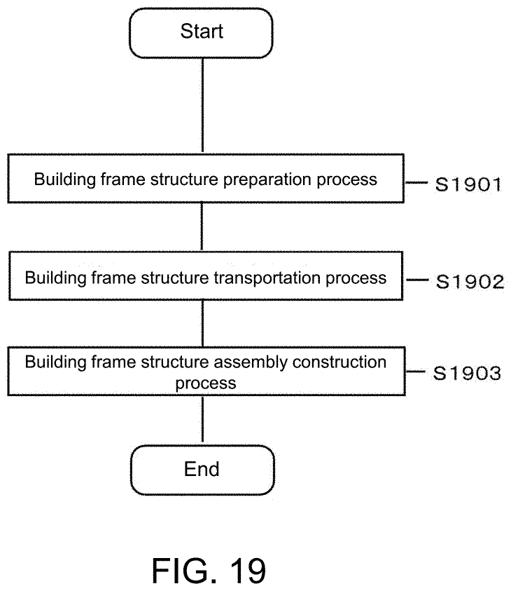

FIG. 19 is a flowchart showing a process flow of the method for constructing a building of the tenth embodiment. As shown in the drawing, the method for constructing a building of the embodiment include a “building frame structure preparation process” S1901, a “building frame structure transportation process” S1902, and a “building frame structure assembly construction process” S1903.

### <Explanation of Configuration of Tenth Embodiment>

### <Explanation of Configuration of Tenth Embodiment, Building Frame Structure Preparation Process>

The “building frame structure preparation process” S1901 is a process of preparing the building frame structure of the second embodiment. The building frame structure is appropriately prepared according to a building to be built. As described in the first embodiment, a place for printing the ID may be provided on the building frame constituting the building frame structure. In the building frame structure preparation process, preferably, the preparation may also be performed using the printed ID.

### <Explanation of Configuration of Tenth Embodiment, Frame Transportation Process>

The “building frame structure transportation process” S1902 is a process of transporting the prepared building frame structure to a construction site. The building frame structure is configured only of the building frames, except for screws used for cross-connection. Therefore, since it is lightweight and easy to handle, it is possible to reduce the need for a transport vehicle to have a high loading capacity and the dependence on skilled and powerful transport personnel. Preferably, a loading order to the transport vehicle is performed to be convenient for assembly at the construction site. In other words, it is convenient to load the building frame structure used for assembly first near a loading/unloading port of the transport vehicle and to load the building frame structure used for late assembly at a position away from the loading/unloading port. In this case, since the building frame structure can be handed over to the assembly directly from the transport vehicle without being covered with soil or the like at the site, a more accurate building can be constructed. Furthermore, since it is not piled up on the site, the risk of exposure to rain and wind can be reduced. The loading onto the transport vehicle or the like can also be performed by computer instructions based on an assembly flow linked to design drawings such as CAD.

When the building frame structure is stored for a certain period of time from the transportation to the next process in which the building frame structure assembly construction process is performed, the building frame structure is preferably stored using the above-described ID to smoothly carry out the next process.

### <Explanation of Configuration of Tenth Embodiment, Building Frame Structure Assembly Construction Process>

The “building frame structure assembly construction process” S1903 is a process of assembling the transported building frame structure into a building frame structure assembly. A building frame structure assembly is a framework or structure of a building. An assembling work of the building frame structures is performed two-dimensionally or three-dimensionally by arranging and connecting a plurality of building frame structures transversely (left and right) or longitudinally (vertically). As described above, it is possible to easily and quickly construct the framework and structure of the building using the lightweight and easy-to-handle building frame structure. For the assembling work, it is convenient to perform the assembling work using identification information printed on the building frame. Further, it is also conceivable to cause an assembly robot to read the identification information and to perform an automatic assembling work. The building frame structure assembly is generally fixed on a foundation by a fixing bracket or the like protruding on the foundation such as concrete. It is also possible to construct a building with two floors or more using the building frame structure. In this case, the wall surface up to about a second floor can be constructed by the building frame structure alone. Regarding a floor member on the second floor, when a transfer width thereof is longer than about 4 meters, it is conceivable to dispose a support member downward to pour concrete into the floor and to support the concrete until solidification. Actually, it is necessary to keep a shape thereof in a state in which it can be maintained correctly, and thus, it is conceivable to use a support member or a hooking member from above. When a building with three floors or more is constructed, a wall surface up to a second floor is formed by pouring concrete into the building panel structure and solidifying the concrete, and then a building frame structure or a building panel structure for a third floor or higher is formed. Finally, even in a building with ten floors or more, the building having sufficient strength can be constructed by the building frame structure of the present application or a building panel structure which will be described later.

### <Explanation of Configuration of Tenth Embodiment, Wall Panel Installation Process>

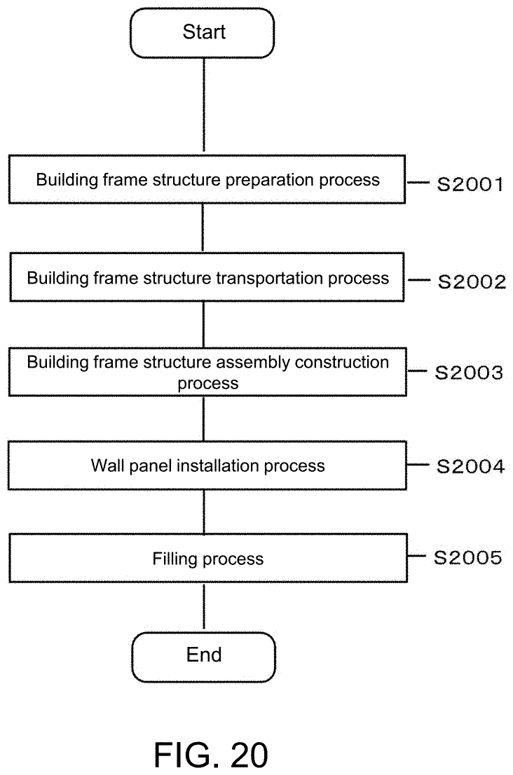

FIG. 20 shows a flowchart showing a process flow in a method for constructing a building in which a wall panel installation process and a filling process are further added to the above-described processes. As shown in the drawing, the construction method includes a “building frame structure preparation process” 52001, a “building frame structure transportation process” 52002, a “building frame structure assembly construction process” 52003, a “wall panel installation process” 52004, and a “filling process” 52005. The construction method may further include only the wall panel installation process.

In the “wall panel installation process” 52004, a wall panel is installed to cover a main surface of the assembled building frame structure assembly. The “main surface” is a surface of which a normal axis is a center normal axis of a space surface surrounded by the building frame and created by a cross-connection part of the building frame structure constituting the building frame structure assembly. Specifically, it is a surface formed by a plane which commonly includes a straight portion of a convex region on the repeated front or back surfaces of building frames that are disposed in parallel and repeatedly disposed on a building frame structure, or a plane parallel thereto.

In the wall panel installation process, a wall panel using a concrete panel, plywood, or the like is installed to cover the main surface of the building frame. The mode of installation is as described in the third embodiment.

### <Explanation of Configuration of Tenth Embodiment, Filling Process>

The “filling process” 52005 is a process of filling concrete in a space sandwiched by wall panels or/and a heat insulating material of a building frame structure assembly. The mode of filling concrete is as described in the fifth embodiment. In addition, concrete may be filled after a heat insulating material is disposed between the wall panels. The filling of concrete is performed by pouring concrete between wall panels from above the wall surface. Therefore, a bottom portion of the building frame structure should be configured to prevent concrete from flowing out.

According to the construction method, since concrete can be filled after the building frame structure assembly is constructed at the construction site, construction can be performed easily and quickly compared to a conventional construction method in which panels filled with concrete in advance are assembled, and the like. Whereas a building using conventional reinforced concrete and having the same strength as the present invention usually takes about one month or more to be constructed, the present application has an advantage that it can be constructed in about 2 to 5 days and labor cost can be significantly reduced.

### Eleventh Embodiment

### <Outline of Eleventh Embodiment>

An eleventh embodiment is a method for constructing a building using the building panel structure of any one of the third to sixth embodiments.

### <Configuration of Eleventh Embodiment>

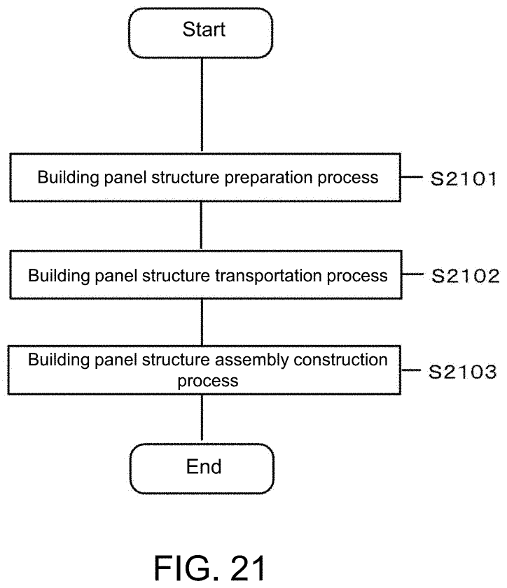

FIG. 21 is a flowchart showing a process flow in the method for constructing a building of the eleventh embodiment. As shown in the drawing, the method for constructing a building of the embodiment includes a “building panel structure preparation process” 52101, a “building panel structure transportation process” 52102, and a “building panel structure assembly construction process” 52103.

### <Explanation of Configuration of Eleventh Embodiment, Building Panel Structure Preparation Process>

The “building panel structure preparation process” 52101 is a process of preparing the building panel structure according to any one of the third to sixth embodiments. The building panel structure is appropriately prepared according to a building to be constructed. As described in the third to sixth embodiments, in the building panel structure, it is possible to dispose a heat insulating material and, in some cases, to fill it with concrete. It is also preferable to attach an ID to the prepared building panel structure.

### <Explanation of Configuration of Eleventh Embodiment, Building Panel Structure Transportation Process>

The “building panel structure transportation process” 52102 is a process of transporting the prepared building panel structure to the construction site. Since the building panel structure in which only the wall panels are disposed and the building panel structure in which only the heat insulating material is disposed are lightweight and easy to handle, it is possible to reduce the need for a transport vehicle to have a high loading capacity and the dependence on skilled and powerful transport personnel.

When the building panel structure is stored for a certain period of time from the transportation to the next process in which the building frame structure assembly construction process is performed, the building panel structure is preferably stored using the above-described ID to smoothly carry out the next process. Further, what has been described in the building frame structure transportation process of the tenth embodiment can also be applied to the building panel structure transportation process.

### <Explanation of Configuration of Tenth Embodiment, Building Panel Structure Construction Process>

The “building panel structure assembly construction process” 52103 is a process of assembling the transported building panel structure into a building panel structure assembly. The building panel structure assembly is a panel used in various places such as an outer wall and an inner wall of a building, a floor, a ceiling, and a roof, and is formed by connecting the panels variously two-dimensionally and three-dimensionally.

As described above, since the building panel structure can have the heat insulating material disposed therein (including containment) or can be filled with concrete, the building panel structures are assembled according to a place to be used and form a building panel structure assembly.

### <Explanation of Configuration of Eleventh Embodiment, Filling Process>

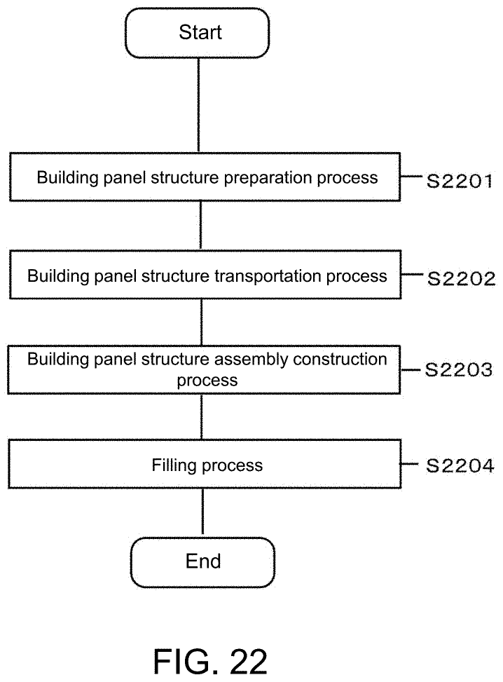

FIG. 22 shows a flowchart showing a process flow in a method for constructing a building in which a filling process is further added to the above-described processes. As shown in the drawing, the construction method includes a “building panel structure preparation process” 52201, a “building panel structure transportation process” 52202, a “building panel structure construction process” 52203, and a “filling process” 52204.

The “filling process” 52204 is a process of filling concrete in a space sandwiched by wall panels or/and a heat insulating material of a building panel structure assembly. The mode of filling concrete is as described in the fifth embodiment. In addition, concrete may be filled after a heat insulating material is disposed between the wall panels.

According to the construction method, since concrete can be filled after the building panel structures are assembled at the construction site to form the building panel structure assembly, construction can be carried out easily and quickly compared to a conventional method in which panels filled with concrete in advance are prepared, transported, and assembled to make panels such as a roof which is an outer wall.

### <Comprehensive Effect>

As described above, since the present invention can construct a building equivalent to a conventional reinforced concrete building at low cost and in a short period of time and particularly can provide a low-cost and sturdy building, it can be used for many purposes such as poor people in developing countries, emergency evacuation buildings in the event of a major disaster, and residential buildings for refugees in conflict areas.

### REFERENCE SIGNS LIST

0101L U-shaped part
0101R U-shaped part
0102 Connection part
0103 Center space
0104L Bent portion of U-shaped part
0104R Bent portion of U-shaped part
0105L Bent portion of U-shaped part
0105R Bent portion of U-shaped part
0106L Bent portion of U-shaped part
0106R Bent portion of U-shaped part

1. A building frame comprising:
U-shaped parts disposed on left and right sides so as to sandwich a center space in a cross-sectional view; and
a connection part which connects top portions of the left and right U-shaped parts on a center side and thus constitutes a reverse U-shaped part,
wherein longitudinal sides, on a side away from a center portion, of the U-shaped parts disposed on the left and right sides in a cross-sectional view are shorter than longitudinal sides thereof, on a center side, connected by the connection part.

2. The building frame according to claim 1, wherein a bottom side of each of the U-shaped parts has at least a predetermined straight portion in a cross-sectional view.

3. The building frame according to claim 1, wherein an upper side of the connection part has at least a predetermined straight portion in a cross-sectional view.

4. A building frame structure comprising a cross-connection part which cross-connects the building frames according to claim 1.

5. The building frame structure according to claim 4, wherein the cross-connection part uses the building frame configured using a rod-shaped body which penetrates and fixes a straight portion of one building frame and a straight portion of another building frame.

6. A building panel structure in which a wall panel which covers a main surface is disposed on the building frame structure according to claim 4 in a contact manner.

7. A building panel structure in which a wall panel which covers a main surface is disposed on the building frame structure according to claim 4 in a non-contact manner.

8. The building panel structure according to claim 6, wherein a heat insulating material is disposed in a frame space formed by the cross-connection parts of the building frame structure.

9. The building panel structure according to claim 6, wherein a heat insulating material is disposed between the building frames disposed parallel to and adjacent to each other in the building frame structure.

10. The building panel structure according to claim 7, wherein a heat insulating material is disposed between the building frame of the building frame structure and the wall panel.

11. The building panel structure according to claim 6, wherein concrete is filled between the wall panels including each of the U-shaped parts of the building frame of the building frame structure.

12. The building panel structure according to claim 11, wherein the wall panel is removed.

13. A building panel structure which is the building panel structure according to claim 6, wherein the building frame is a “building frame including:
U-shaped parts disposed on left and right sides so as to sandwich a center space in a cross-sectional view; and
a connection part which connects top portions of the left and right U-shaped parts on a center side and thus constitutes a reverse U-shaped part,
wherein longitudinal sides, on a side away from a center portion, of the U-shaped parts disposed on the left and right sides in a cross-sectional view have the same length as longitudinal sides thereof, on a center side, connected by the connection part” in place of or in addition to a “building frame including:
U-shaped parts disposed on left and right sides so as to sandwich a center space in a cross-sectional view; and
a connection part which connects top portions of the left and right U-shaped parts on a center side and thus constitutes a reverse U-shaped part,
wherein longitudinal sides, on a side away from a center portion, of the U-shaped parts disposed on the left and right sides in a cross-sectional view are shorter than longitudinal sides thereof, on a center side, connected by the connection part”.

14. A building panel structure which is the building panel structure according to claim 6, wherein as the building frame, a “building frame including:
U-shaped parts disposed on left and right sides so as to sandwich a center space in a cross-sectional view; and
a connection part which connects top portions of the left and right U-shaped parts on a center side and thus constitutes a reverse U-shaped part,
wherein longitudinal sides, on a side away from a center portion, of the U-shaped parts disposed on the left and right sides in a cross-sectional view are shorter than longitudinal sides thereof, on a center side, connected by the connection part” is used as a longitudinal member, and
C-shaped, U-shaped, H-shaped, and L-shaped frames are used in place of or in addition to a “building frame including:
U-shaped parts disposed on left and right sides so as to sandwich a center space in a cross-sectional view; and
a connection part which connects top portions of the left and right U-shaped parts on a center side and thus constitutes a reverse U-shaped part,
wherein longitudinal sides, on a side away from a center portion, of the U-shaped parts disposed on the left and right sides in a cross-sectional view are shorter than longitudinal sides thereof, on a center side, connected by the connection part” as transverse members.

15. A building panel structure which is the building panel structure according to claim 6, wherein as the building frame, C-shaped, U-shaped, H-shaped, and L-shaped frames are used in place of or in addition to a “building frame including:
U-shaped parts disposed on left and right sides so as to sandwich a center space in a cross-sectional view; and
a connection part which connects top portions of the left and right U-shaped parts on a center side and thus constitutes a reverse U-shaped part,
wherein longitudinal sides, on a side away from a center portion, of the U-shaped parts disposed on the left and right sides in a cross-sectional view are shorter than longitudinal sides thereof, on a center side, connected by the connection part”.

16. A method for constructing a building, the method comprising:
a building frame structure preparation process of preparing the building frame structure according to claim 4;
a building frame structure transportation process of transporting the prepared building frame structure to a construction site; and
a building frame structure assembly construction process of assembling the transported building frame structures into a building frame structure assembly.

17. The method for constructing a building according to claim 16, further comprising a wall panel installation process of installing a wall panel to cover a main surface of the assembled building frame structure assembly.

18. The method for constructing a building according to claim 17, further comprising a filling process of filling a space sandwiched by the wall panels or/and a heat insulating material of the building frame structure assembly with concrete.

19. A method for constructing a building, the method comprising:
a building panel structure preparation process of preparing the building panel structure according to claim 6;
a building panel structure transportation process of transporting the prepared building panel structure to a construction site; and
a building panel structure assembly construction process of assembling the transported building panel structures into a building panel structure assembly.

20. The method for constructing a building according to claim 19, further comprising a filling process of filling a space sandwiched by the wall panels or/and a heat insulating material of the building panel structure assembly with concrete.
